(19) United States
(12) Patent Application Publication
(10) Pub. No.: US 2015/0174625 A1
(43) Pub. Date: Jun. 25, 2015

(54) ARTICLES WITH MONOLITHIC, STRUCTURED SURFACES AND METHODS FOR MAKING AND USING SAME

(71) Applicants: CORNING INCORPORATED, Corning, NY (US); ICFO (THE INSTITUE OF PHOTONIC SCIENCES), Barcelona (ES); ICREA (INSTITUTE CATALANA DE RECERCA I ESTUDIS AVANCATS), Barcelona (ES)

(72) Inventors: Shandon Dee Hart, Corning, NY (US); Karl William Koch, III, Elmira, NY (US); Domenico Tulli, Valencia (ES); Prantik Mazumder, Ithaca, NY (US); Valerio Pruneri, Castelldefels (ES); Paul Arthur Sachenik, Corning, NY (US); Lili Tian, Laurel, MD (US); Johann Osmond, Barcelona (ES); Albert Carrilero, Cardedeu (ES)

(21) Appl. No.: 14/625,010

(22) Filed: Feb. 18, 2015

Related U.S. Application Data
(63) Continuation-in-part of application No. 13/687,227, filed on Nov. 28, 2012, now Pat. No. 9,023,457.
(60) Provisional application No. 61/565,188, filed on Nov. 30, 2011.

(51) Int. Cl. B08B 17/06; G06F 3/041

(52) U.S. Cl. CPC B08B 17/065; G06F 3/041; G06F 2203/04103

(57) ABSTRACT

A textured article that includes a transparent substrate having at least one primary surface and a glass, glass-ceramic or ceramic composition; a micro-textured surface on the primary surface of the substrate, the micro-textured surface comprising a plurality of hillocks; and a nano-structured surface on the micro-textured surface, the nano-structured surface comprising a plurality of nano-sized protrusions or a multilayer coating comprising a plurality of layers having a nano-scale thickness. Further, the hillocks have an average height of about 10 to about 1000 nm and an average longest lateral cross-sectional dimension of about 1 to about 100 μm, and the nano-sized protrusions have an average height of about 10 to about 500 nm and an average longest lateral cross-sectional dimension of about 10 to about 500 nm. The substrate may be chemically strengthened with a compressive stress greater than about 500 MPa and a compressive depth-of-layer greater than about 15 μm.

### CROSS-REFERENCE TO RELATED APPLICATIONS

This application claims the benefit of priority under 35 U.S.C. §120 and is a continuation-in-part of U.S. patent application Ser. No. 13/687,227, filed on Nov. 28, 2012, which claims the benefit of priority under 35 U.S.C. §119 of U.S. Provisional Application Ser. No. 61/565,188, filed on Nov. 30, 2011, the content of which are relied upon and incorporated herein by reference in their entirety, and the is hereby claimed.

### BACKGROUND

The present disclosure relates generally to micro- and nano-textured and -structured surfaces and articles. More particularly, the various embodiments described herein relate to articles having micro-scale features and nanoscale features such that the articles exhibit improved antiglare, antireflection and/or tunable wetting properties, as well as to methods of making and using the articles.

Touch-sensitive devices, such as touch screen surfaces (e.g., surfaces of electronic devices having user-interactive capabilities that are activated by touching specific portions of the surfaces), have become increasingly more prevalent. In general, the surfaces of these articles should exhibit high optical transmission, low haze, high durability, and low reflectivity, among other features.

The optical properties of these touch-sensitive devices, other display devices (e.g., laptop displays) and self-cleaning surfaces, are important. Notably, antiglare (AG) and/or anti-reflection (AR) treatments to surfaces of these articles can improve their optical properties. AG surfaces, for example, use diffusion mechanisms to scatter light that is reflected from a surface or interface. The diffusive aspects of AG surfaces reduce the coherence of the reflected images from the external environment, making unwanted images unfocused to the eye. Consequently, the AG surfaces provide enhanced viewing of the intended image in the display device. One drawback associated with AG surfaces is that their presence may sacrifice clarity, contrast under ambient lighting, and resolution of the intended images in the displays.

Unlike diffusion-based AG surfaces, AR surfaces and structures can reduce the total reflection (including all angles of light output) from a surface or interface, rather than only scattering the angular distribution of reflected light. AR surfaces and structures suppress reflections using interference or sub-wavelength effects. These surfaces and structures can be created, for example, by varying the refractive index in these surfaces and structures.

In some specific applications involving intense ambient light, AR surfaces have been employed in combination with AG surfaces in polymeric films and structures to mitigate any loss in clarity and resolution associated with the AG surface. The injection molding and hot-embossing processes employed to generate polymeric AR/AG surfaces are specific to polymeric systems and cannot be used with any practical effect with higher-viscosity glass and other high-temperature glass-ceramic and ceramic systems. Further, polymeric systems have limited utility in many touch-sensitive devices, display devices and self-cleaning surfaces because of their relatively low temperature stability, scratch-resistance and hardness relative to glass, glass-ceramic and ceramic systems.

There accordingly remains a need for technologies that provide touch screen, display device, self-cleaning and other aesthetic or functional surfaces with improved optical properties. It would be particularly advantageous if such technologies did not adversely affect other desirable properties, such as mechanical resistance, of the surfaces and/or significantly increase the time, complexity, and/or cost required to make such surfaces. It would also be particularly advantageous if such surface technologies offered the high-temperature stability of underlying substrates comprising glass, glass-ceramic and ceramic compositions employed in such applications. It is to the provision of such technologies that the present disclosure is directed.

### BRIEF SUMMARY

Described herein are various methods for making textured articles, textured articles that have improved AG, AR and/or tunable wetting properties.

One type of textured article includes a transparent substrate having at least one primary surface; a micro-textured surface on the primary surface of the substrate, the micro-textured surface comprising a plurality of hillocks; and a nano-structured surface on the micro-textured surface. The nano-structured surface may include a nano-textured surface comprising a plurality of nano-sized protrusions or a compositionally nano-structured surface comprising a multi-layer coating including a plurality of layers each having a nano-scale thickness. Further, the hillocks may have an average height of about 10 to about 1000 nm and an average longest lateral cross-sectional dimension of about 1 to about 100 μm, and the nano-sized protrusions may have an average height of about 10 to about 500 nm and an average longest lateral cross-sectional dimension of about 10 to about 500 nm.

In another aspect of the disclosure, a textured article is provided that includes a transparent substrate having at least one primary surface; a micro-textured surface on the primary surface of the substrate, the micro-textured surface comprising a plurality of hillocks; and a nano-structured surface on the micro-textured surface. The nano-structured surface may include a nano-textured surface comprising a plurality of nano-sized protrusions or a compositionally nano-structured surface comprising a multi-layer coating. Further, the hillocks may have an average height of about 10 to about 1000 nm and an average longest lateral cross-sectional dimension of about 1 to about 100 μm. Where utilized, the nano-sized protrusions may have an average height of about 10 to about 500 nm and an average longest lateral cross-sectional dimension of about 10 to about 500 nm. The hillocks, in certain aspects, can have an average height of about 50 to about 500 nm and average longest lateral cross-sectional dimension of about 1 to about 100 μm. In certain aspects of the disclosure, the nano-sized protrusions have an average height of about 10 to about 300 nm and average longest lateral cross-sectional dimension of about 10 to 300 nm. In addition, the substrate may be chemically strengthened and have a compressive stress greater than about 500 MPa and a compressive depth-of-layer greater than about 15 μm.

In certain implementations, the textured article can comprise a portion of a touch-sensitive display screen or cover plate for an electronic device, a non-touch-sensitive component of an electronic device, a surface of a household appliance, a surface of a vehicle component, a surface of an optical component or optical device, a surface of a window, a surface of a photodetector, a surface of an imaging device, a surface of a photovoltaic device, or a surface of an architectural feature.

According to an additional aspect of the disclosure, a method of forming a textured article is provided that includes the steps: providing a transparent substrate having at least one primary surface and a glass, glass-ceramic or ceramic composition; forming a micro-textured surface on the primary surface of the substrate, the micro-textured surface comprising a plurality of hillocks; and forming a nano-structured surface on the micro-textured surface. In some embodiments, the nano-structured surface includes either one or more of a nano-textured surface or a compositionally nano-structured surface. Where a nano-textured surface is utilized, the method includes forming a continuous ultra-thin metal-containing film or film stack on the micro-textured surface; dewetting at least a portion of the continuous ultra-thin metal-containing film or film stack to produce a plurality of discrete metal-containing dewetted islands on the micro-textured surface; and wet or dry etching at least portions of the micro-textured surface on which the islands are not disposed to define a nano-textured surface on the micro-textured surface, the nano-textured surface comprising a plurality of nano-sized protrusions. Where a compositionally nano-structured surface is utilized, the method includes forming a multilayer coating including a plurality of layers each having a nano-scale thickness and alternating high and low refractive indices.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments. Directional terms as used herein—for example, up, down, right, left, front, back, top, bottom—are made only with reference to the figures as drawn and are not intended to imply absolute orientation.

### BRIEF DESCRIPTION OF THE DRAWINGS

FIGS. 1A through 1H are a series of schematics depicting a method for making a textured article according to an aspect of the disclosure.

FIGS. 2 and 2A are two schematics depicting a method for making a textured article having a compressive stress depth-of-layer (DOL) according to an aspect of the disclosure.

FIGS. 3A and 3B are scanning electron microscope (SEM) images of dewetted copper nanoparticles derived from a 4 nm thick copper film on a non-textured and an antiglare (AG) surface, respectively, according to aspects of the disclosure.

FIGS. 4A and 4B are scanning electron microscope (SEM) images of self-assembled, dewetted copper nanoparticles derived from a 4 nm thick copper film and an 8 nm thick copper film, respectively, on an antiglare (AG) surface according to aspects of the disclosure.

FIG. 4C is an atomic force microscope (AFM) image and scan of an AG surface populated with dewetted copper nanoparticles derived from a 4 nm thick copper film according to an aspect of the disclosure.

FIGS. 5A and 5B are AFM images and scans of AG surfaces before and after a 700° C. thermal treatment indicative of a metal dewetting step for preparing an AR surface, respectively, according to an aspect of the disclosure.

FIG. 6A is an AFM image and scan of an AG micro-textured surface populated with an AR, nano-textured surface according to an aspect of the disclosure.

FIG. 6B is a higher-magnification AFM image and scan of the AG micro-textured surface populated with the AR, nano-textured surface depicted in FIG. 6A.

FIGS. 7A and 7B are SEM images of an AG micro-textured surface populated with a nano-textured surface derived from 4 nm thick copper films, according to an aspect of the disclosure.

FIGS. 7C and 7D are SEM images of an AG micro-textured surface populated with a nano-textured surface derived from 8 nm thick copper films, according to an aspect of the disclosure.

FIG. 8A is a plot that presents total, axial and diffuse optical transmission and reflection data for AG micro-textured and AR nano-textured surfaces according to an aspect of the disclosure.

FIGS. 8B and 8C are plots that present total and specular reflectivity data for AG micro-textured and AR nano-textured surfaces and a non-textured surface according to an aspect of the disclosure.

FIG. 9A is a photo of a 2 mL water droplet on an AG micro-textured and AR nano-textured surface having a fluorosilane coating according to an aspect of the disclosure.

FIG. 9B is an SEM image of the AG micro-textured and AR nano-textured surface depicted in FIG. 9A after portions of it were subjected to 100 wipes with a fiber cloth at a force of 6 N over a surface area of 2 cm².

These and other aspects, advantages, and salient features will become apparent from the following detailed description, the accompanying drawings, and the appended claims.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts. Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Provided herein are various textured articles that have improved AR, AG, and tunable wetting properties, methods for making the textured articles, and methods of using the textured articles. The methods and articles generally include the use of at least two different sets of micro-textured and/or nano-structured topographical features that are created within and/or on the surface of the article substrate. In aspects of this disclosure, these micro-textured and nano-structured surfaces are monolithic in the sense that the micro-textured and nano-textured surfaces have the same or a similar composition as the substrate with little to no interfaces between these surfaces and the substrate. In other aspects of this disclosure, the substrate and these surfaces are monolithic in the sense that they have no discernible interfaces between them. As used herein, the term “monolithic” means that no interfaces exist, or are discernible (i.e., discernible through standard analytical techniques as understood by those with ordinary skill in the field of this disclosure including but not limited to scanning electron and transmission electron microscopy techniques), between the substrate and the micro-textured and nano-textured surfaces (e.g., substrate 50 and surfaces 60 and 70). In some aspects, the nano-structured surface is not monolithic and includes a different composition from the substrate and, in some instances, a different composition from the micro-textured surface.

These groups of different textured topographical features can render the surfaces hydrophilic and oleophilic, or hydrophobic and oleophobic. In addition, the textured/structural aspects of these surfaces can impart both AR and AG properties in the article having such surfaces. Further, and as will be described in more detail below, the textured articles can exhibit high transmission, low haze, low reflectivity, and high durability, among other features.

In addition, the term “oleophobic” is used herein to refer to a material that imparts a wetting characteristic such that the contact angle between oleic acid and a surface formed from the material is greater than 90 degrees (°). Analogously, the term “hydrophobic” is used herein to refer to a material that imparts a wetting characteristic such that the contact angle between water and a surface formed from the material is greater than 90°.

As used herein, the terms “antiglare” and “AG” refer to antiglare optical properties of surfaces as characterized by an ability to scatter light that is reflected from a surface or interface. Further, the terms “antireflective” and “AR” refer to antireflective optical properties of surfaces as characterized by an ability to reduce or otherwise suppress reflections within a surface or interface.

As stated above, the articles of the disclosure generally include a substrate and at least two different sets of micro-textured and nano-structured features that are created in or on a surface of the substrate. Each set of topographical features can have at least one average dimensional attribute that is different from that of any other set of nano-structured topographical features. The dimensional attributes that can be different include volume, height, and/or lateral cross-sectional dimension. For example, a set of micro-structured features can have a different lateral cross-sectional dimension in comparison to the lateral cross-sectional dimension of a set of nano-structured features employed in the article.

As used herein, the term “lateral cross-sectional dimension” refers to the longest particular dimension of an object in a cross-section of that object that is parallel to the surface of the substrate. Thus, to clarify, when a nano-textured topographical feature is circular in cross-section, the longest lateral cross-sectional dimension is its diameter; when a nano-textured topographical feature is oval-shaped in cross-section, the longest lateral cross-sectional dimension is the longest diameter of the oval; and when a nano-textured topographical feature has an irregularly-shaped cross-section, the longest lateral cross-sectional dimension is the line between the two farthest opposing points on the perimeter of the island. In some embodiments, either or both of the micro-textured and/or nano-structured surfaces may have a topographical pattern that is random or semi-random. This randomness may be characterized using various known topographical or spatial orientation metrics, such as the distribution of surface heights, Fourier transform or diffraction methods, radial distribution function of feature peaks or feature centers, and the like.

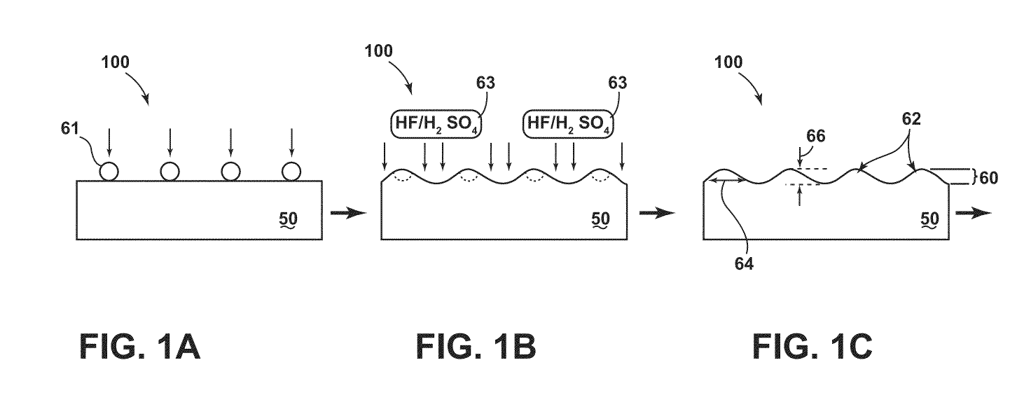

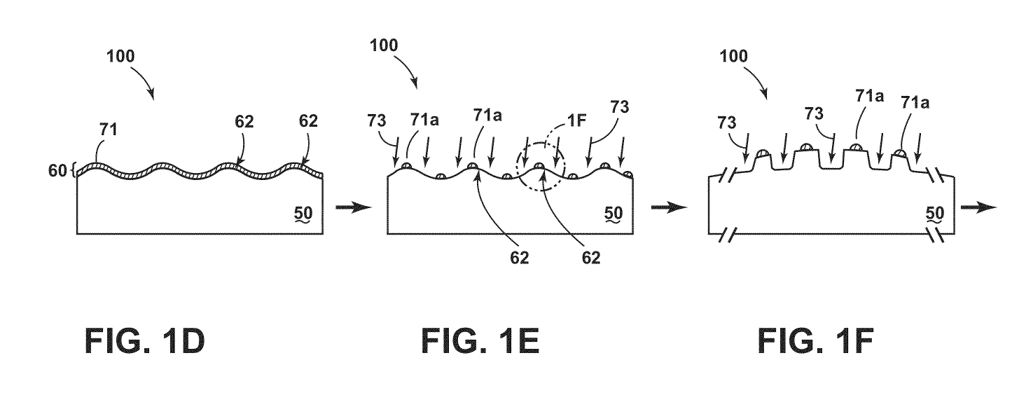

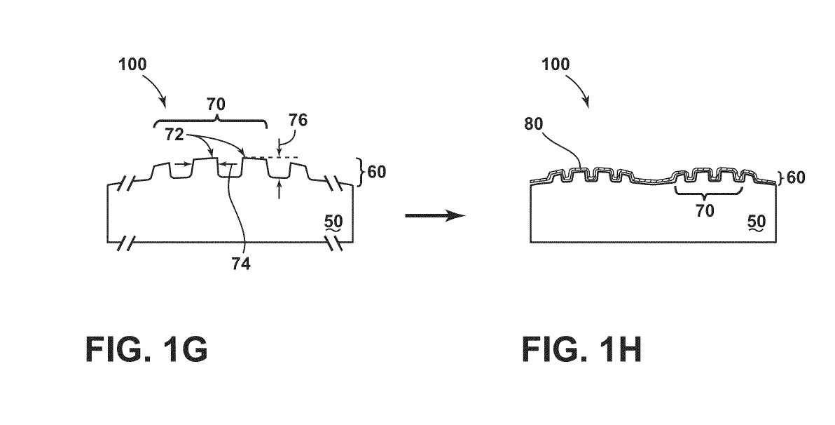

FIGS. 1A through 1H provide a series of schematics that depict a method for making a textured article 100 according to an aspect of the disclosure. Referring to FIGS. 1C, 1G and 1H, the textured article 100 includes a transparent substrate 50 having at least one primary surface and a glass, glass-ceramic or ceramic composition. As shown in FIG. 1C, the article further includes a micro-textured surface 60 on the primary surface of the substrate 50. The micro-textured surface 60 includes multiple hillocks 62. Further, the hillocks 62 can have an average height 66 of about 10 to about 1000 nm and an average longest lateral cross-sectional dimension 64 of about 1 to about 100 μm. In some aspects, the hillocks 62 can have an average height 66 of about 50 to 500 nm.

In FIG. 1G, it is also apparent that the textured article 100 includes a nano-textured surface 70 on the micro-textured surface 60. The nano-textured surface 70 includes a plurality of nano-sized protrusions 72. Further, the nano-sized protrusions 72 have an average height 76 of about 10 to about 500 nm and an average longest lateral cross-sectional dimension 74 of about 10 to about 500 nm. In some aspects, the nano-sized protrusions can have an average height 76 of about 10 to about 300 nm. The nano-sized protrusions can also have an average longest lateral cross-sectional dimension 74 of about 10 to about 300 nm.

Referring again to FIG. 1G, various population densities of the nano-sized protrusions 72 of the nano-textured surface 70 on the micro-textured surface 60 are feasible. In one implementation, the nano-sized protrusions 72 cover about 30 to 70% of the micro-textured surface 60. In other aspects, the nano-sized protrusions 72 can cover 10%, 20%, 30%, 40%, 50%, 60%, 80%, or up to 90% of the micro-textured surface 60.

It should be noted that the nano-sized protrusions 72 of the nano-textured surface 70 can have various shapes besides the mesa-like shapes depicted as serrated edges in cross-section within FIG. 1G. Those skilled in the art to which this disclosure pertains will recognize that a variety of other shaped features can be used for the nano-sized protrusions 72 including, but not limited to, cones, pyramids, cylinders, helices, tapered cylinders, toroids, and the like. The hillocks 62 of the micro-textured surface 60 can also have various shapes besides the hill-like shapes depicted as wave-like features in cross-section within FIG. 1C. For example, those with ordinary skill in the field of this disclosure will recognize that a variety of other shaped features can be used for the hillocks 62 including, but not limited to, cones, pyramids, cylinders, tapered cylinders, bumps, mesas, peaks and other similarly-shaped features.

Similarly, the relative sizes of the dimensional attributes of the various textured features of the textured articles 100 shown in FIGS. 1C and 1G are merely illustrative of the relative size scales that can be implemented in the textured articles described herein. Those skilled in the art to which this disclosure pertains will recognize that the dimensional attributes can be varied from those shown in FIGS. 1C and 1G, to include situations where the average volumes, average heights, and/or average lateral cross-sectional dimensions of secondary, tertiary, quaternary, and so on, sets of nanostructured topographical features are larger than those of the primary set of nanostructured topographical features. Additionally, while the various schematic illustrations of FIGS. 1C and 1G depict one set of nano-textured topographical features disposed on one set of micro-textured topographical features, it is possible for multiple sets of nano-textured and/or micro-textured topographical features to be disposed on the substrate and/or on each other.

Where a compositionally nano-structured surface is utilized, such a surface may include a multi-layer coating formed on the micro-textured surface. The multi-layered coating may include a plurality of layers including alternating high refractive index layers and low refractive index layer. For example, the multi-layer coating may include a first low refractive index (RI) sub-layer and a second high RI sub-layer. The difference between the refractive index of the first low RI sub-layer and the refractive index of the second high RI sub-layer may be about 0.01 or greater (e.g., about 0.1 or greater, about 0.2 or greater, about 0.3 or greater or about 0.4 or greater). In one or more embodiments, the multi-layer coating includes a plurality of sub-layer sets (e.g., up to about 10 sub-layer sets), which can include a first low RI sub-layer and a second high RI sub-layer. The first low RI sub-layer may include one or more of SiO₂, Al₂O₃, GeO₂, SiO, AlOₓN_{y}, SiOₓN_{y}, SiᵤAlᵥOₓN_{y}, MgO, MgF₂, BaF₂, CaF₂, DyF₃, YbF₃, YF₃, and CeF₃. The second high RI sub-layer may include at least one of SiᵤAlᵥOₓN_{y}, Ta₂O₅, Nb₂O₅, AlN, Si₃N₄, AlOₓN_{y}, SiOₓN_{y}, HfO₂, TiO₂, ZrO₂, Y₂O₃, Al₂O₃, and MoO₃.

In some instances, the multi-layer coating may include a third sub-layer. The third sub-layer may be disposed between the plurality of sub-layer sets and the micro-textured surface. Alternatively, the third sub-layer may from part of the sub-layer sets (i.e., the sub-layer sets may include a first sub-layer, a second sub-layer and a third sub-layer). The third sub-layer of one or more embodiments may have a RI between the refractive index of the first low RI sub-layer and the refractive index of the second high RI sub-layer.

The first low RI sub-layer and/or the second high RI sub-layer of the multi-layer coating may have an optical thickness (n*d) in the range from about 2 nm to about 200 nm. The multi-layer coating may exhibit a thickness of about 800 nm or less or about 500 nm or less. The multi-layer coating may be conformal and conform to the underlying micro-textured surface or the coating may be non-conformal.

Referring to FIG. 1H, the textured article 100 may also include a hydrophobic coating 80 (e.g., a fluorosilane composition) disposed over the micro-textured surface 60 and nano-textured surface 70 (or a compositionally nano-structured surface, not shown). In some aspects, the coating 80 is coated, deposited or otherwise created in situ on the textured surfaces 60 and 70 (or a compositionally nano-structured surface, not shown) using any of various processes understood by those with ordinary skill in the art (e.g., dip coating, spray coating, ink-jetting, doctor blade application, etc.). In some aspects, as depicted in FIG. 1H, the hydrophobic coating 80 conforms to the underlying structure of the nano-textured surface 70 and does not substantially fill in any gaps between the nano-sized protrusions 72. Where a compositionally nano-structured surface is utilized, a bonding layer may be formed to bond the hydrophobic coating 80 to the multi-layer coating, not shown. Further, the fluorosilane coating is disposed such that the contact angle between water and the fluorosilane coating is greater than or equal to about 90 degrees, or greater than or equal to about 120 degrees. In certain aspects, the hydrophobic coating 80 produces a super-hydrophobic character such that the contact angle between water and the coating is greater than 150 degrees. It should be understood that the hydrophobic coating 80, when used in connection with the textured article 100, can possess various compositions and film structures as understood by those with ordinary skill in the field of this disclosure, provided that the coating 80 is hydrophobic in nature as-deposited on the surfaces 60 and 70.

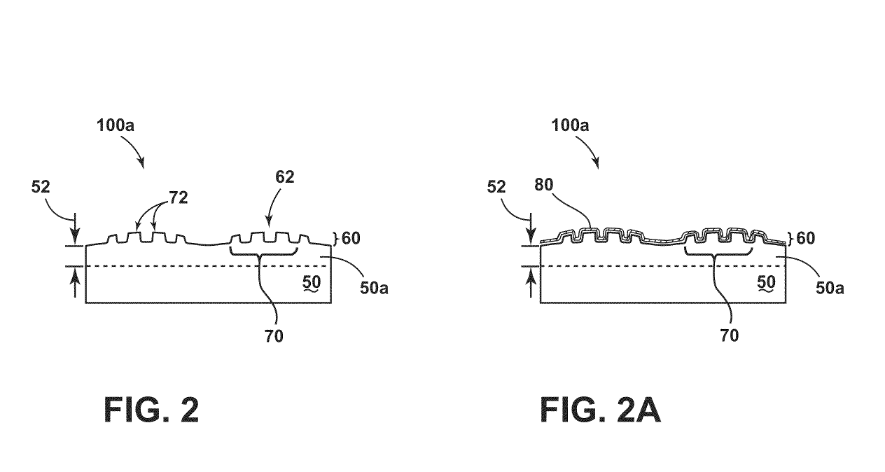

Referring to FIGS. 2 and 2A, a textured article 100a is provided that is largely similar to the textured article 100 depicted in FIGS. 1G and 1H. In particular, like-numbered elements (e.g., hydrophobic coating 80, micro-textured surface 60, etc.) depicted as part of the textured articles 100, 100a in FIGS. 1G, 1H, 2 and 2A have identical or substantially similar structures and functions, unless otherwise noted herein. The primary difference between the textured articles 100 and 100a is that the textured article 100a depicted in FIGS. 2 and 2A possesses a substrate 50 that is chemically strengthened with a compressive stress region 50a. More specifically, the compressive stress region 50a extends from at least primary surface of the substrate 50 to a first depth 52. One advantage of the compressive stress region 50a within the textured article 100a is that it can increase the average mechanical strength, decrease the variability in strength values observed in a population of such articles 100a (i.e., by raising the Weibull modulus, m), and/or increase the characteristic strength (i.e., the strength that corresponds to a failure probability of 63%) of such articles 100a.

With further regard to the textured article 100a, the compressive stress region 50a possesses a maximum compressive stress of at least 200 MPa, typically at the surface of the substrate 50. In some aspects, the maximum compressive stress in the region 50a is at least 300 MPa, 400 MPa, 500 MPa and higher depending on the composition of the substrate 50 and/or the processes used to chemically strengthen it. Further, the first depth 52 is at least 5 μm within the substrate, thus defining a depth-of-layer (DOL) for the compressive stress region within the textured article 100a. In some aspects, the first depth 52 is at least 10 μm, 15 μm, 20 μm, and deeper within the substrate 50.

The processes employed to chemically strengthen the textured article 100a include ion-exchange methods and other suitable processes that can be used to strengthen glass, glass-ceramic and ceramic substrate compositions as understood by those with ordinary skill in the field of this disclosure. For example, a substrate 50 having an alkali-containing glass composition can be exposed to a molten salt bath containing larger anions (e.g., K⁺ ions from a KNO₃ salt bath). The smaller anions (e.g., Na⁺ ions and/or Li⁺ ions) in the substrate are exchanged by the larger ions, thus creating a layer of compressive stress in regions of the substrate exposed to the molten salt bath. It should be understood that compressive stress may be generated using a single bath, two successive baths or multiple baths. The molten salt bath may include a uniform composition (e.g., only KNO₃, only NaNO₃, only LiNO₃ and the like) or a mixed bath (e.g., a mixture of any one or more of KNO₃, NaNO₃, and LiNO₃).

Advantageously, the processes used to strengthen the textured articles 100a, including ion-exchange processes, can also be used to strengthen the micro-textured and nano-textured surfaces 60 and 70, respectively, in some aspects of this disclosure. In those implementations in which the surfaces 60 and 70 are monolithic with regard to the substrate 50, the processes employed to strengthen the surfaces 60 and 70 can be conducted at the same time as the processes for strengthening the substrate 50. In contrast, the surfaces associated with polymeric systems with AR and/or AG properties cannot be so strengthened with the typical processes used to strengthen glass, glass-ceramic and ceramic substrates due to too high process temperatures and substrate chemical compositions. It should also be understood that chemically-strengthened surfaces 60 and 70 in textured articles 100a possess DOLs that exceed the primary dimensions of the hillocks 62 and nano-sized protrusions 72 of these surfaces.

In embodiments where a compositionally nano-structured surface is utilized, the substrate may include the compressive stress region 50a, and the compositionally nano-structured surface may not be processed to include any compressive stress, independent of any potential compressive stress present in the compositionally nano-structured surface from forming (e.g., compressive stress levels that are the direct result of deposition of the multi-layer coating). In such embodiments, the substrate may be chemically strengthened as described herein before the compositionally nano-structured surface is formed.

The topography and durability of the microtextured and nanostructured surface can be further modified using other surface treatment methods such as sintering, wet chemical etching, and hydrothermal sintering. These methods can be used to modify the topography to achieve optical targets, or to reduce the sharpness of surface flaws in order to increase mechanical strength.

The methods of making the textured articles 100, 100a (see FIGS. 1G, 1H, 2 and 2A) are depicted in FIGS. 1A through 1G. The methods generally involve the step: providing a transparent substrate 50 having at least one primary surface and a glass, glass-ceramic or ceramic composition; and forming a micro-textured surface 60 on the primary surface of the substrate, the micro-textured surface 60 comprising a plurality of hillocks 62 (see FIGS. 1A-1C). In certain aspects, as shown in FIG. 1A, a polymeric mask 61 is applied to the primary surface of the substrate 50 designated for the micro-textured surface 60. The mask 61 can be in the form of particles and the mask can be fused to the primary surface of the substrate 50. Next, the substrate 50 is etched as shown in FIG. 1B with a suitable acid 63 (e.g., HF/H₂SO₄), preferentially between the particles or other features (e.g., a mesh) of the mask 61. By controlling the composition of the acid 63, the etching temperature and/or the surface composition of the substrate 50, a micro-textured surface 60 can be created as shown in FIG. 1C with hillocks 62 having an average longest lateral dimension 64 and an average height dimension 66. Further, the hillocks 62 produced according to the foregoing methods can have an average height 66 of about 10 to about 1000 nm and an average longest lateral cross-sectional dimension 64 of about 1 to about 100 μm. In some aspects of the methods, the hillocks 62 can have an average height 66 of about 50 to 500 nm.

The methods of making the textured articles 100, 100a also includes forming a nano-structured surface on the micro-textured surface. In some embodiments, where a nano-textured surface is utilized, the method includes forming a continuous film 71 (e.g., an ultra-thin metal-containing film or a film stack) on the micro-textured surface 60 (see FIG. 1D); and a step of dewetting at least a portion of the continuous film 71 to produce a plurality of discrete metal-containing dewetted islands 71a on the micro-textured surface 62 (see FIG. 1E). In some aspects of the method, the continuous film 71 applied to the micro-textured surface 60 (see FIG. 1D) is covered by a copper ultrathin metal film (UTMFs) on the order of 1 to 10 nm in thickness using sputtering techniques. In certain aspects, the sputtered copper films employed for the continuous film 71 have a thickness of about 4 to 8 nm. It should be understood, that such films can have an average thickness of 1 nm, 2 nm, 3 nm, 4 nm, 5 nm, 6 nm, 7 nm, 8 nm, 9 nm, 10 nm, 11 nm, 12 nm, 13 nm, 14 nm and 15 nm. It should also be understood that the continuous film 71 may also be UTMFs comprising other materials including Ag, Ni, Ti, and Au metals and alloys.

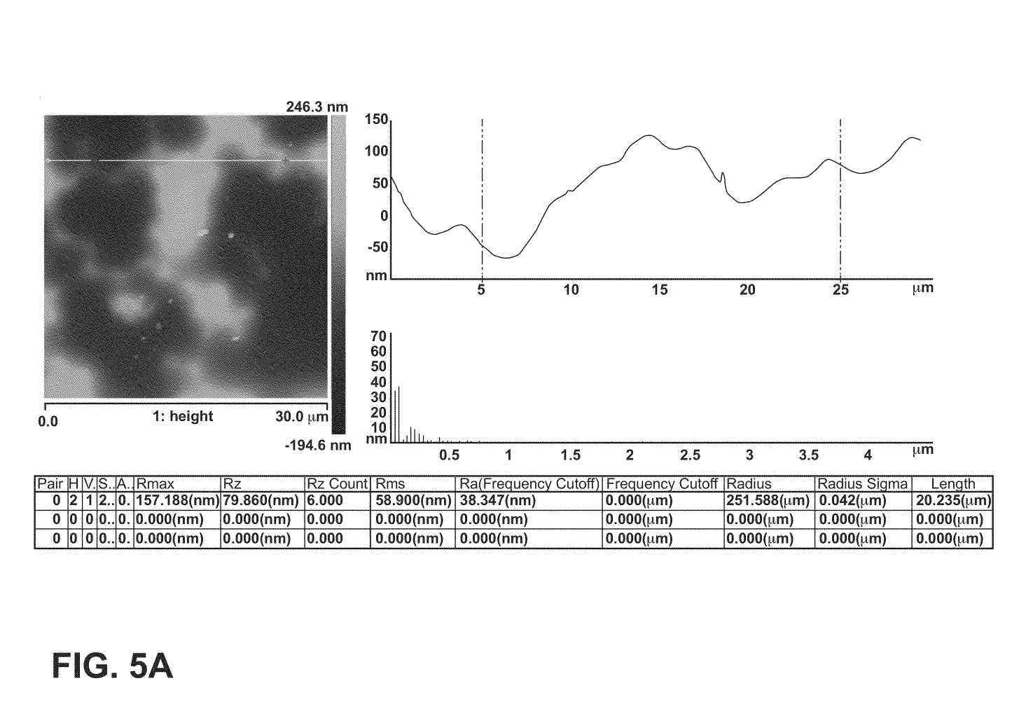

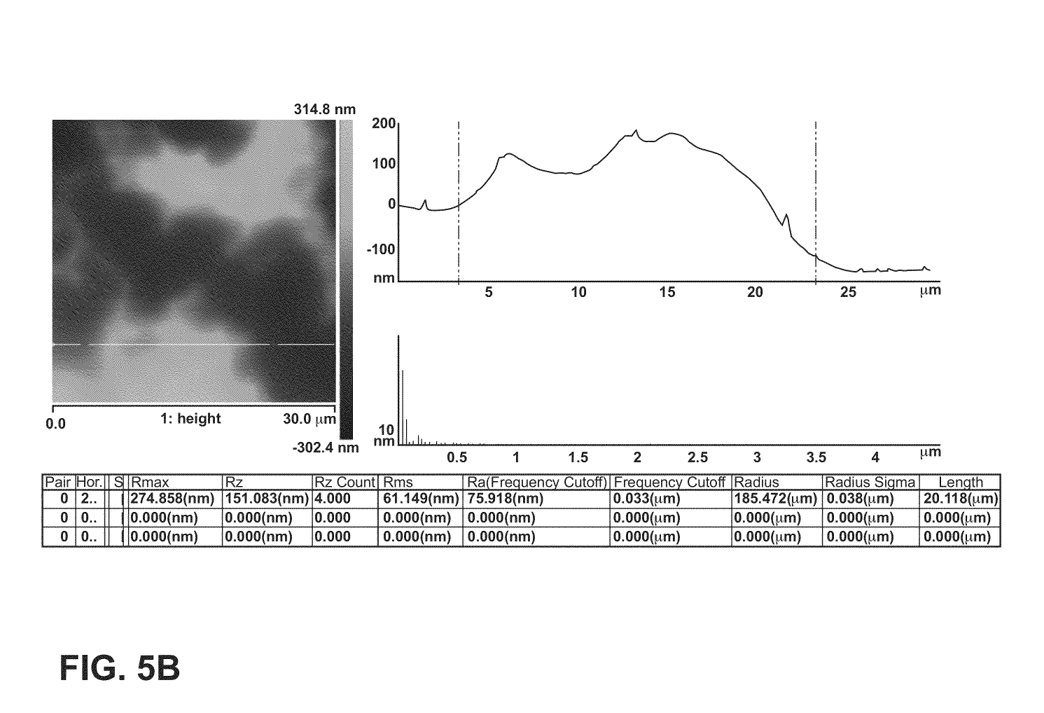

With regard to the dewetting step of the methods for producing textured articles 100, 100a, it can be effected by heating the substrate 50 and film 71 to a temperature of 300° C. or higher. In some aspects, the substrate 50 and film 71 can be heated to a temperature in excess of 400° C. or higher, 500° C. or higher, 600° C. or higher, 700° C. or higher, and even higher than 800° C. In certain implementations in which the textured article 100, 100a contains a substrate having a glass or glass-ceramic composition, a dewetting temperature can, advantageously, be employed near, or even above, the glass transition temperature of the substrate. As shown in FIGS. 5A and 5B, for example, dewetting steps conducted at or near the glass transition temperature of the substrate do not affect the dimensions of the hillocks 62 of the micro-textured surface 60. In particular, FIGS. 5A and 5B provide AFM images and scans of AG, micro-textured surfaces before and after a 700° C. thermal treatment indicative of a metal dewetting step for preparing an AR, nano-textured surface. It is evident from FIGS. 5A and 5B that the dimensions of the hillocks do not significantly change upon the exposure to the 700° C. thermal treatment. As such, the methods employed to produce textured articles 100, 100a can rely on relatively high dewetting temperatures which can, advantageously, be used to produce high particle densities of islands 71a having relatively small sizes on average.

The temperature and duration selected for the dewetting step are made in consideration of the temperature stability of the particular glass, glass-ceramic or ceramic composition of the substrate 50, intended dimensions and population density of the islands 71a, among other considerations. In one preferred implementation, the dewetting step is conducted at 750° C. for about 95 seconds to produce a number of islands 71a (see, e.g., FIG. 1E). It should also be understood that the dewetted islands 71a produced according to the methods of making textured articles 100, 100a are nano-sized, typically with dimensions on the order of nanometers.

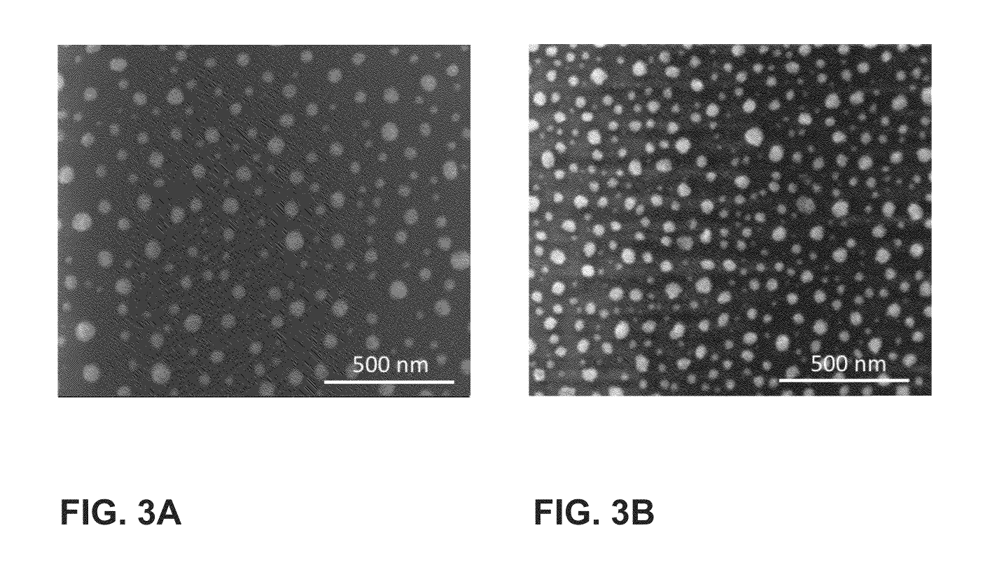

As demonstrated by FIGS. 3A and 3B, the dewetting step is particularly effective in developing dewetted islands 71a when conducted on a micro-textured surface 60 in comparison to a flat substrate surface lacking such a micro-textured surface. In particular, FIGS. 3A and 3B are SEM images of dewetted copper nanoparticles derived from a 4 nm thick copper film (i.e., continuous film 71) formed over a non-textured, flat surface (FIG. 3A) and an antiglare (AG) surface (FIG. 3B), respectively, according to aspects of the disclosure. The dewetted islands 71a deposited on the non-textured, flat substrate surface exhibited a particle density of 104 particles per cm² and an average diameter of 47.4 nm. Surprisingly, the dewetted islands 71a deposited on the micro-textured, AG surface on a substrate demonstrated an even higher density with smaller particle sizes, namely, a particle density of 179 particles per cm² and an average diameter of 38.7 nm.

Substrates having micro-textured surfaces with dewetted islands (e.g., islands 71a) formed from continuous copper films consistent with the disclosure have been characterized with optical transmission techniques. The optical spectra exhibited by these samples have demonstrated a well-defined dip between wavelengths of 550 and 650 nm, consistent with local surface plasmon resonance effects of nano-sized copper particles. In some aspects of the method, the dewetted islands 71a are randomly distributed on the micro-textured surfaces 60 (see FIG. 1E), but are statistically uniform over the entire micro-textured surface 60 of the substrate 50 at large length scales compared to the typical size of the nano-sized protrusions 72. Preferably, the parameters of the steps for forming the continuous film 71 and dewetting the film 71 are optimized to ensure statistically uniform coverage of the islands 71a on the micro-textured surface 60. The degree of uniformity in the distribution of the islands 71a can positively impact the desired combination of the AG and AR effects indicative of the textured articles 100, 100a.

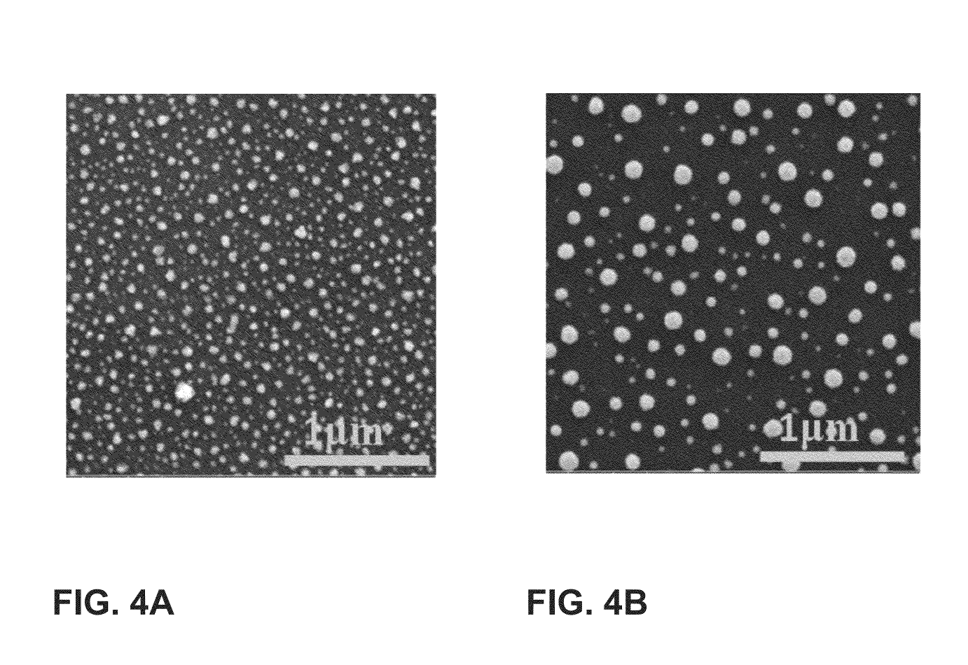

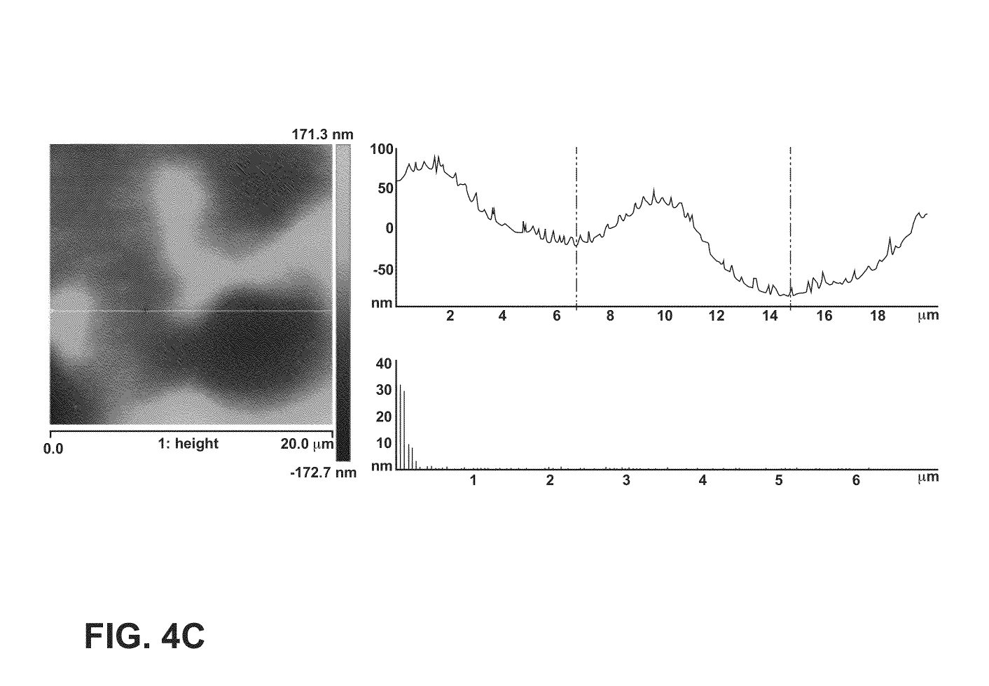

Referring to FIGS. 4A and 4B, SEM images of self-assembled, dewetted copper nanoparticles derived from a 4 nm thick copper film and an 8 nm thick copper film, respectively, on a micro-textured, antiglare (AG) surface are provided according to aspects of the disclosure. As evidenced by the SEM images in these figures, the dewetted islands 71a formed from the 4 and 8 mm thick copper films have a uniform distribution. What is also evident is that use of a thicker copper film (i.e., 8 nm vs. 4 nm) results in larger sizes for the islands 71a and a lower particle density.

Referring to FIG. 4C, an AFM image and scan of an AG, micro-textured surface populated with dewetted copper nanoparticles (e.g., islands 71a) derived from a 4 nm thick copper film is provided according to an aspect of the disclosure. As shown in the AFM image and scan of FIG. 4C, the metal nanoparticles are small peaks that populate the larger-scale micro-textured surface containing hillocks. The nanoparticles are randomly distributed over the hillocks, but are also statistically uniform across the micro-textured AG surface. Further, the metal nanoparticles depicted in FIG. 4C have height dimensions on the order of about 10-20 nm and the hillocks have height dimensions on the order of about 50 nm.

As depicted in FIGS. 1E and 1F, the methods of making the textured articles 100, 100a further include a step of wet or dry etching at least portions of the micro-textured surface 60 on which the islands 71a are not disposed to define a nano-textured surface 70 on the micro-textured surface 60. Dry etching is preferred in some embodiments because of the better process control in creating protrusions of the desired shape. The net effect of the dry etching step is the creation of the nano-textured surface 70 comprising a plurality of nano-sized protrusions 72. More specifically, the dry etching step can be accomplished with the use of dry etchant 73, employed to preferentially etch regions of the micro-textured surface 60 not covered by the islands 71a. One suitable process for the dry etching step is a reactive ion etching (RIE) procedure that employs high-energy ions as the dry etchant 73.

By controlling the size and density of the islands 71a (e.g., as depicted in FIGS. 4A and 4B) on the micro-textured surface 60 via the dewetting step and the dry etching step parameters can be employed to produce nano-sized protrusions 72 of the nano-textured surface 70 having various dimensions and population densities integrated within the micro-textured surface 60. Through control of such process variables, it is possible to tailor the nanostructures associated with the nano-textured surface 70 as well as the optical properties of the textured articles 100, 100a. For example, thicker initial continuous films 71 lead to lower density and larger dewetted islands 71a, contributing to larger nano-sized protrusions 72. In one aspect of the method, the nano-sized protrusions 72 have an average height 76 of about 10 to about 500 nm and an average longest lateral cross-sectional dimension 74 of about 10 to about 500 nm (see FIG. 1G). In some aspects, the nano-sized protrusions 72 can have an average height 76 of about 10 to about 300 nm. The nano-sized protrusions 72 can also have an average longest lateral cross-sectional dimension 74 of about 10 to about 300 nm.

The methods of making the textured articles 100, 100a also includes forming a compositionally nano-structured surface on the micro-textured surface. In some embodiments, where a compositionally nano-structured surface is utilized, the method includes forming a multi-layer coating on the micro-textured surface using liquid-based techniques, for example sol-gel coating or other coating methods (e.g., spin, spray, slot draw, slide, wire-wound rod, blade/knife, air knife, curtain, gravure, and roller coating) and/or vacuum forming processes, for example, chemical vapor deposition (e.g., plasma enhanced chemical vapor deposition, low-pressure chemical vapor deposition, atmospheric pressure chemical vapor deposition, and plasma-enhanced atmospheric pressure chemical vapor deposition), physical vapor deposition (e.g., reactive or nonreactive sputtering or laser ablation), thermal or e-beam evaporation and/or atomic layer deposition.

Provision of the substrate 50 first involves selection of an appropriate material for use as the substrate. This choice will be made based on the particular use of the textured article 100, 100a. In general, however, a variety of substrates can be used. For example, the substrate can be a glass material, a glass-ceramic material, a ceramic material, or the like.

By way of illustration, with respect to glasses, the material chosen for the substrate 50 can be any of a wide range of silicate, borosilicate, aluminosilicate, or boroaluminosilicate glass compositions, which optionally can comprise one or more alkali and/or alkaline earth modifiers. One such glass composition includes the following constituents: 58-72 mole percent (mol %) SiO₂; 9-17 mol % Al₂O₃; 2-12 mol % B₂O₃; 8-16 mol % Na₂O; and 0-4 mol % K₂O, wherein the ratio

$$\frac{{Al}_{2} {O}_{3} ( mol \% ) + {B}_{2} {O}_{3} ( mol \% )}{\sum modifiers ( mol \% )} > 1 ,$$

where the modifiers comprise alkali metal oxides. Another glass composition includes the following constituents: 61-75 mol % SiO₂; 7-15 mol % Al₂O₃; 0-12 mol % B₂O₃; 9-21 mol % Na₂O; 0-4 mol % K₂O; 0-7 mol % MgO; and 0-3 mol % CaO. Yet another illustrative glass composition includes the following constituents: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 parts per million (ppm) As₂O₃; and less than 50 ppm Sb₂O₃; wherein 12 mol %≦Li₂O+Na₂O+K₂O≦20 mol %, and 0 mol %≦MgO+CaO≦10 mol %. Still another illustrative glass composition includes the following constituents: 55-75 mol % SiO₂, 8-15 mol % Al₂O₃, 10-20 mol % B₂O₃; 0-8% MgO, 0-8 mol % CaO, 0-8 mol % SrO, and 0-8 mol % BaO.

Similarly, with respect to glass-ceramics employed as the substrate 50, the material chosen can be any of a wide range of materials having both a glassy phase and a ceramic phase. Illustrative glass-ceramics include those materials where the glass phase is formed from a silicate, borosilicate, aluminosilicate, or boroaluminosilicate, and the ceramic phase is formed from β-spodumene, β-quartz, nepheline, kalsilite, or carnegieite.

If the substrate 50 is formed from a ceramic material, it can be any of a variety of oxides, carbides, nitrides (e.g., boron nitride), oxycarbides, carbonitrides, or the like, whether in polycrystalline or single crystal form. One such ceramic is polycrystalline Al₂O₃. Another illustrative ceramic is polycrystalline SiC. Yet another illustrative ceramic material is single-crystal GaAs (e.g., as used in the fabrication of certain semiconductor devices) or single-crystal Al₂O₃ (e.g., sapphire).

Regardless of the material chosen for the substrate 50, the substrate can adopt a variety of physical forms. That is, from a cross-sectional perspective, the substrate 50 can be flat or planar, or it can be curved and/or sharply-bent. Similarly, it can be a single unitary object, or a multi-layered structure or laminate.

In certain situations, the substrate 50 can be subjected to an optional treatment prior to disposing the at least two sets of micro-textured and nano-structured topographical features on the surface of the substrate. Examples of such treatments include physical or chemical cleaning, physical or chemical strengthening (e.g., by thermal tempering, chemical ion-exchange, or like processes in the case of a glass), physical or chemical etching, physical or chemical polishing, annealing, sintering, shaping, and/or the like. Such processes are known to those skilled in the art to which this disclosure pertains.

Once the substrate 50 has been selected and/or prepared, each set of micro-textured and nano-structured topographical features can be disposed thereon or created therein. Before the first set of micro- or nano-structured topographical features (e.g., micro-textured surface 60 or nano-textured surface 70) can be disposed on, or created in, the surface of the substrate, the materials used for the particular set of micro-textured topographical features should be selected. As with the substrates, a variety of materials can be used. If a given set of micro-textured or nano-structured topographical features will be created in the surface of the substrate, then the material chosen will be that of the substrate itself. If, however, the set of micro-textured or nano-structured topographical features will be disposed on the surface of the substrate 50, the material used to make the set of textured topographical features can be the same as, or different than, that of the substrate. For example, the material can be a glass material, a glass-ceramic material, and/or a ceramic material.

Notwithstanding the foregoing, other techniques can be used to dispose the sets of micro-textured and nano-structured topographical features with the requisite dimensions on the surface of the substrate 50 in further implementations of the textured articles 100, 100a. In such implementations, the micro-textured and nano-structured surfaces 60 and 70, respectively, may or may not be monolithic with respect to the underlying substrate 50. By way of example, each set of micro-textured and/or nano-structured topographical features independently can be fabricated using any of the variants of chemical vapor deposition (CVD) (e.g., plasma-enhanced CVD, aerosol-assisted CVD, metal organic CVD, and the like), any of the variants of physical vapor deposition (PVD) (e.g., ion-assisted PVD, pulsed laser deposition, cathodic arc deposition, sputtering, glancing angle deposition (GLAD), and the like), atomic layer deposition, self-assembly of nanoparticles, or the like. Such processes are known to those skilled in the art to which this disclosure pertains.

Similarly, a variety of techniques can be used to create the sets of micro-textured and nano-textured topographical features within the surface of the substrate 50. In these implementations, the micro-textured and nano-textured surfaces 60 and 70, respectively, are monolithic with respect to the underlying substrate 50. By way of example, these techniques include mechanical attrition of portions of the designated primary surface of the substrate 50, chemical or physical etching of portions of the primary surface with or without a mask, mechanically embossing portions of the primary surface, or the like. Such processes are known to those skilled in the art to which this disclosure pertains.

Given the breadth of potential uses for the textured articles 100, 100a described herein, it should be understood that the specific features or properties of a textured article will depend on the ultimate application therefor or use thereof. The following description, however, will provide some general considerations.

In general, the average height 76 of the nano-sized protrusions 72 of the nano-textured surface 70 will be less than or equal to about 550 nm. These heights should be measured from the undulating plane of the micro-textured surface 60, so as not to count the varying height of the micro-textured surface when calculating the average height of the nano-textured surface. If the textured article 100, 100a is to be used in applications where it may be desirable to optimize texturing for reflectivity, durability, weight, or cost characteristics (e.g., in electronic devices, or the like), then even shorter nano-textured topographical features (e.g., about 50 nm to about 300 mm) can be used. By way of example, if the textured article 100, 100a is intended to function as a cover for a touch screen display to provide improved reflection-resistance, then the average height 76 of the nano-sized protrusions 72 of the nano-textured surface 70 can be less than or equal to about 200 nm.

The average lateral cross-sectional dimension 74 of each set of the nano-sized protrusions 72 should be less than or equal to about 550 nm. In some situations, the average lateral cross-sectional dimension 74 of the nano-sized protrusions 72 in the nano-textured surface 70 can be about 10 nm to about 300 nm. In situations where even smaller textured features are desirable, the average lateral cross-sectional dimension 74 of the nano-sized protrusions can be less than or equal to about 150 nm.

In certain aspects of the disclosure, the area fraction of the substrate 50 that is covered by the nano-sized protrusions 72 can be about 0.10 to about 0.9 (e.g., from about 0.1 to about 0.8, from about 0.1 to about 0.7, from about 0.1 to about 0.6, from about 0.2 to about 0.9, from about 0.3 to about 0.9, from about 0.4 to about 0.9, from about 0.5 to about 0.9, or from about 0.6 to about 0.9).

The ratio of the distance between two adjacent topographical features within a given set of topographical features (e.g., hillocks 62 and nano-sized protrusions 72) to the average lateral cross-sectional dimension for that set of topographical features should be less than or equal to about 10:1. In certain aspects, this ratio can be set at less than or equal to about 5:1. In certain other situations, this ratio can be about 1:1 to about 3:1.

In general, the optical transmittance of the textured articles 100, 100a according to aspects of the disclosure will depend on the type of materials chosen for the articles. For example, certain textured articles 100, 100a can have a transparency (i.e., optical transmittance) over the entire visible spectrum of at least about 85%. In certain cases where the textured article is used in the construction of a touch screen for an electronic device, for example, the transparency of the textured articles 100, 100a can be at least about 92% over the visible spectrum. In certain implementations, the transparency of the textured articles 100, 100a can reach or exceed 95%. In situations where the substrate 50 comprises a pigment (or is not colorless by virtue of its material constituents), the transparency can diminish, even to the point of being opaque across the visible spectrum. Thus, there is no particular limitation on the optical transmittance of the textured article 100, 100a itself. Nevertheless, it should be understood that, advantageously, the micro-textured and nano-structured surfaces, respectively, can be configured such that they do not reduce or otherwise degrade the optical transparency or transmittance of the article possessing these surfaces.

The textured and structured surface of the article may exhibit a total reflectance and/or specular reflectance that is less than 2%, less than 1%, or less than 0.8% across a portion of the visible light spectrum, when measuring only the reflectance from the textured surface (i.e., removing additional reflections from a second surface of the transparent article, which may be non-textured).

Like transmittance, the haze of the textured articles 100, 100a can be tailored to the particular application. As used herein, the terms “haze” and “transmission haze” refer to the percentage of transmitted light scattered outside an angular cone of ±2.5° in accordance with ASTM procedure D1003, the contents of which are incorporated herein by reference in their entirety as if fully set forth below. For an optically smooth surface, transmission haze is generally close to zero. In those situations when the textured article 100, 100a is used in the construction of a touch screen for an electronic device, the haze of the textured article can be less than or equal to about 5%. In certain aspects, the optical haze of the textured article 100, 100a can be limited to about 2% or lower.

Another quantifiable indication of the improved tunable wetting property can be seen in the contact angles between the textured articles 100, 100a and water and/or oleic acid (i.e., the hydrophobicity and/or the oleophobicity, respectively). In general, the textured articles 100, 100a described herein are hydrophobic and oleophobic. In addition, the inclusion of the hydrophobic coating 80 (see FIGS. 1H and 2A) over the micro-textured and nano-textured surfaces 60 and 70, respectively, can greatly improve these properties in the textured articles 100, 100a. In some implementations, however, the contact angle between the textured articles 100, 100a and water can be at least about 135 degrees, and the contact angle between the textured article and oleic acid can be at least about 100 degrees. In other implementations, these contact angles can be at least about 150 degrees and at least about 115 degrees, respectively.

In a particular embodiment in which the textured articles 100, 100a possess a hydrophobic coating 80, the textured nature of the primary surface of the substrate 50 containing the micro-textured and nano-textured surfaces 60 and 70, respectively, can improve the resistance of the substrate to degradation in hydrophobic and oleophobic properties over time. In one exemplary aspect, the textured articles 100, 100a possessing a hydrophobic coating 80 comprising a fluorosilane composition experience a contact angle reduction of 10% or less after 100 wipes with a fiber cloth at a force of about 6 N over a 2 cm² portion of the primary surface containing the surfaces 60 and 70. Effectively, the micro-textured and nano-textured surfaces 60 and 70, respectively, aid in the retention of the hydrophobic coating after handling, wear or the like. In addition, the chemically-strengthened textured articles 100a are expected to demonstrate even higher wear resistance for a hydrophobic coating 80 present on the surfaces 60, 70.

Various embodiments of the present disclosure are further illustrated by the following non-limiting examples.

### EXAMPLES

### Example 1

### Effect of Dewetting and Dry Etching Parameters

In Table 1 below, haze and transmittance optical property data are provided for textured articles having micro-textured (AG) and nano-textured surfaces (AR) that were prepared under varying dewetting and dry etching conditions. Also provided in Table 1 for purposes of comparison are optical data associated with a textured article having only an AG surface. The AG surfaces for each of the samples having a glass substrate were prepared according to conditions comparable to those described in the foregoing. With the exception of the “bare AG surface” sample, the AG surfaces of all of the samples were covered with either 4 nm or 8 nm thick copper metal films using sputtering techniques. Dewetting was conducted at 750° C. for 95 s and dry etching was conducted using an RIE step for the durations specified in Table 1.

TABLE 1

| | Initial | | | | | | |
|---|---|---|---|---|---|---|---|
| | metal | | | | | | |
| | thick- | | RIE | | | Water | Oil |
| | ness | | time | T | Haze | CA | CA |
| Sample | (nm) | dewetting | (min) | (%) | (%) | (°) | (°) |
| Bare AG | | | | 92.1 | 0.92 | | |
| surface | | | | | | | |
| AG 4 Cu I | 4 | 750° C., 95 s | 9 | 94.15 | 0.95 | >165 | 90 |
| AG 4 Cu II | 4 | 750° C., 95 s | 5 | 93.57 | 0.92 | >165 | 85 |
| AG 4 Cu III | 4 | 750° C., 95 s | 7 | 93.96 | 0.93 | | |
| AG 8 Cu I | 8 | 750° C., 95 s | 4 | 93.37 | 0.68 | | |
| AG 8 Cu II | 8 | 750° C., 95 s | 6 | 94.35 | 0.84 | 165 | 80 |
| AG 8 Cu III | 8 | 750° C., 95 s | 8 | 94.25 | 1.01 | | |
| AG 8 Cu IV | 8 | 750° C., 95 s | 10 | 93.96 | 1.86 | 90 | 69 |

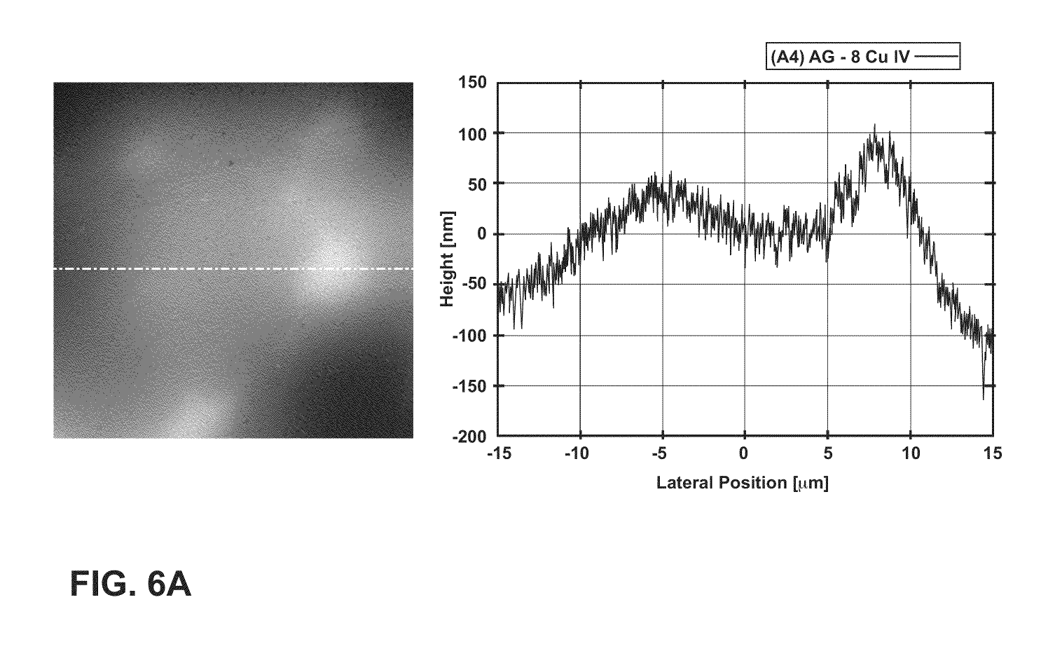

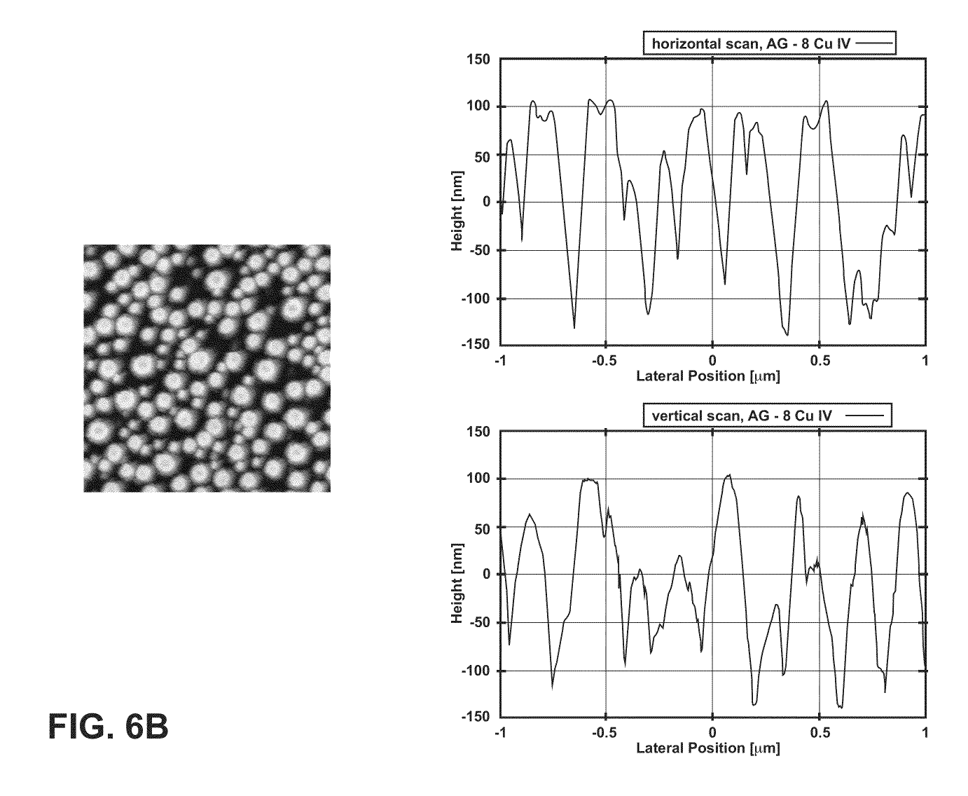

Referring to FIG. 6A, an AFM image and scan is depicted for an AG, micro-textured surface populated with an AR, nano-textured surface that was prepared according to the “AG 8 Cu IV” sample condition listed in Table 1 above. Further, FIG. 6B is a higher-magnification AFM image and scan of the AG and AR surface depicted in FIG. 6A. It is evident from the AFM images and scans in these figures that the AR nano-textured surfaces possess nano-sized protrusions with a height of about 200 nm (see FIG. 6B) that are superposed upon AG micro-textured surfaces inhabited by hillocks having a height on the order of 100-200 nm (see FIG. 6A). It should be noted that the height of the nano-sized protrusions depicted in FIG. 6A is lower than the actual height of these features because the scan pixel size is too large to accurately resolve the structure. Consequently, the height data provided in FIG. 6B more accurately depicts the height of the nano-sized protrusions.

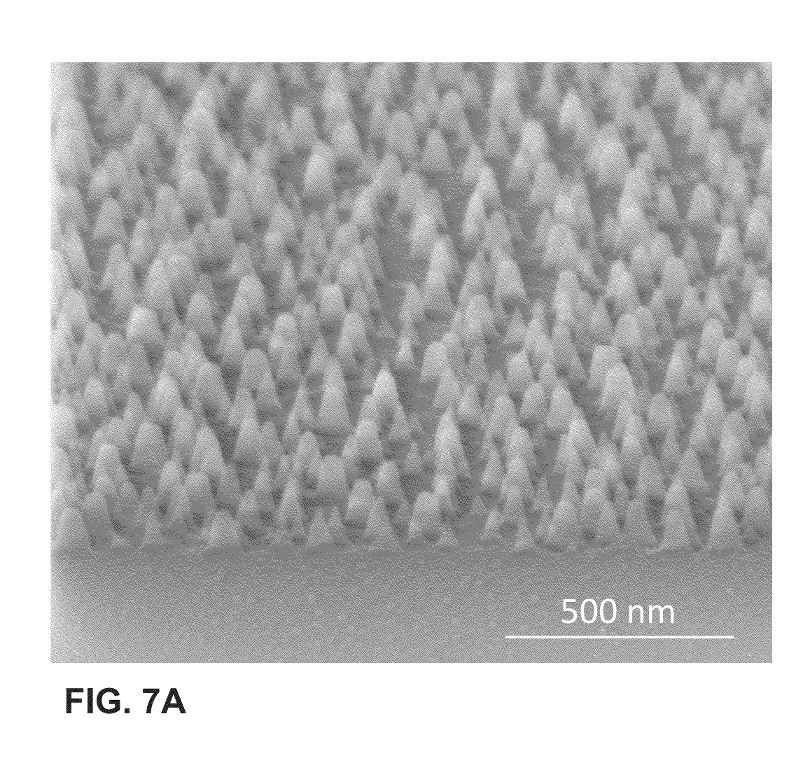

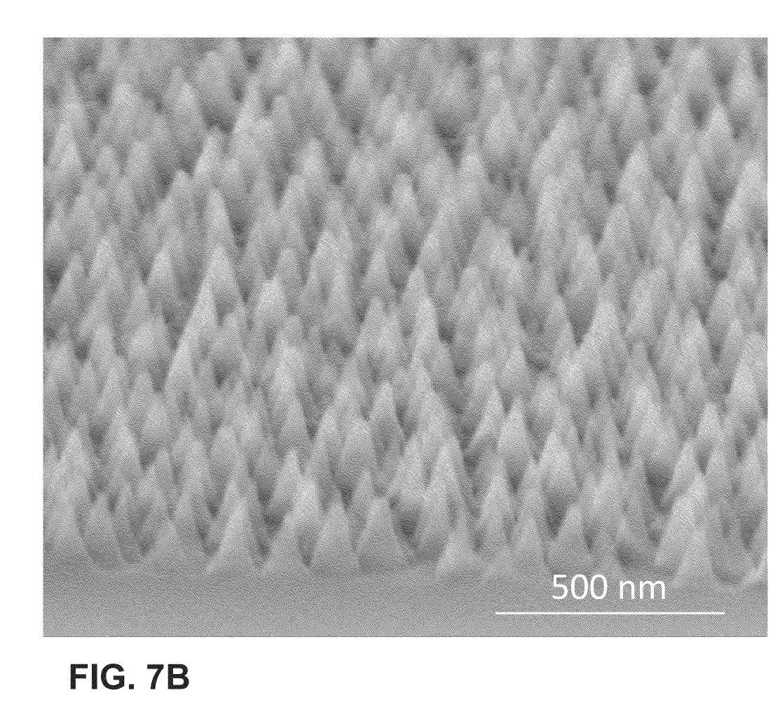

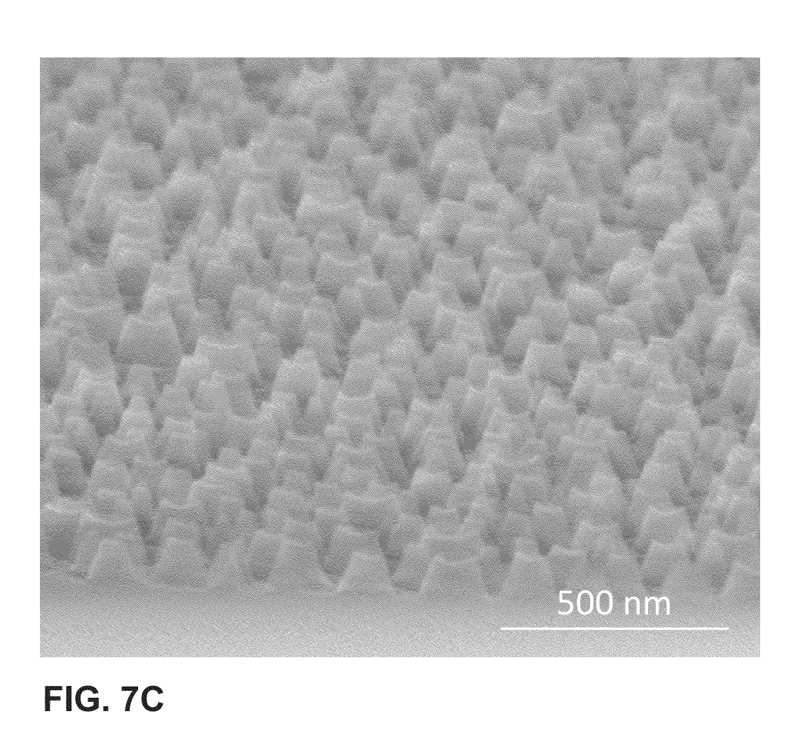

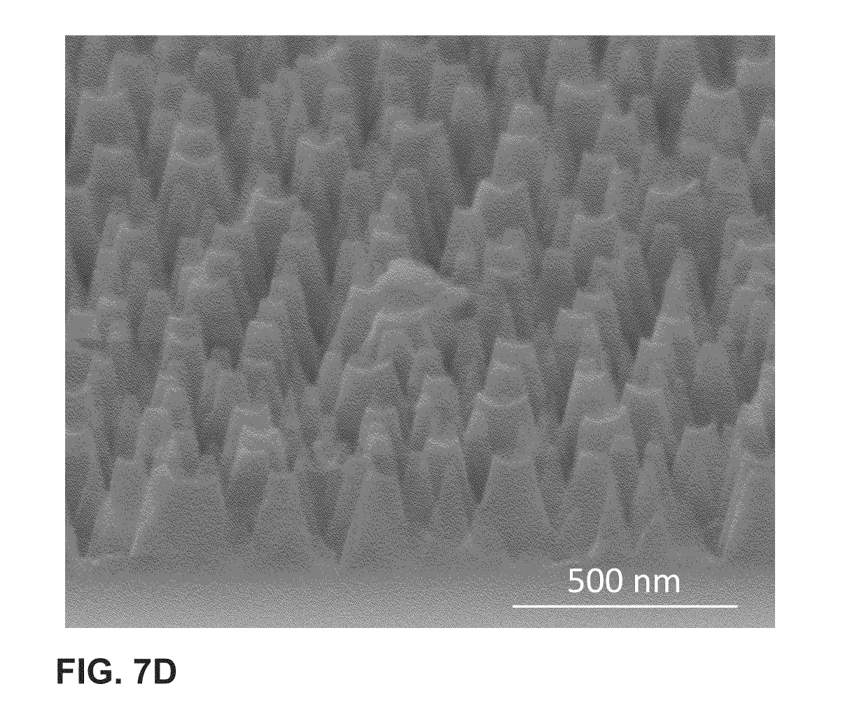

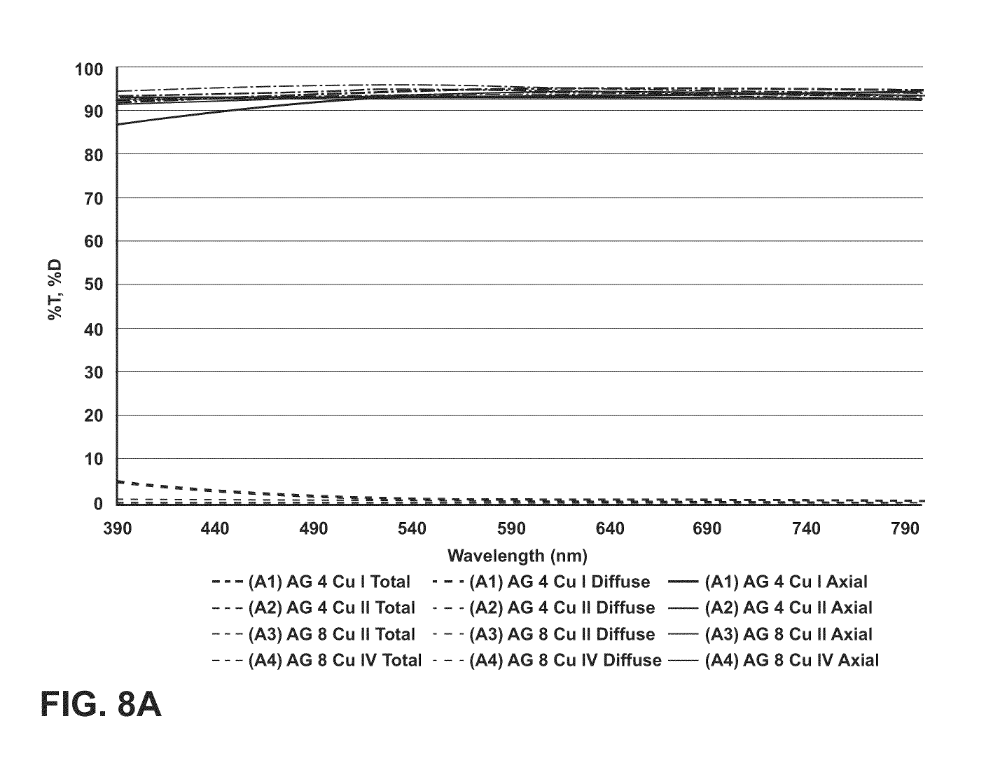

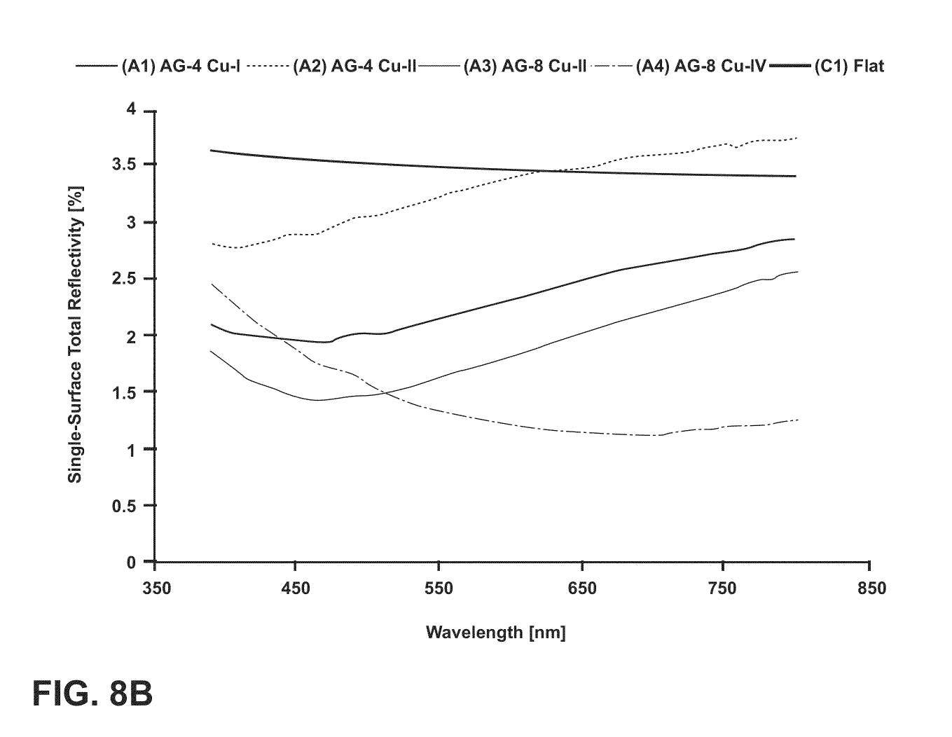

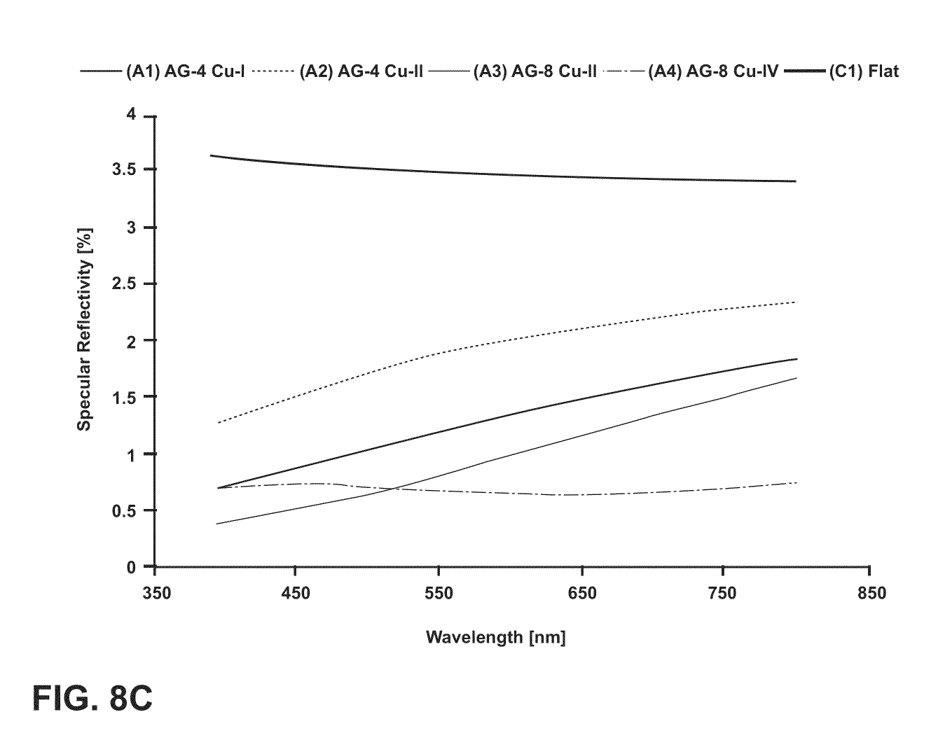

FIGS. 7A, 7B, 7C and 7D are SEM images of an AG micro-textured surface populated with an AR, nano-textured surface derived from 4 nm (FIGS. 7A and 7B) and 8 nm (FIGS. 7C and 7D) thick copper films, according to an aspect of the disclosure. In particular, the sample depicted in FIG. 7A was prepared according to the “AG 4 Cu I” sample condition listed above in Table 1. Similarly, the sample depicted in FIG. 7B was prepared according to the “AG 4 Cu II” sample condition listed above in Table 1. Similarly, the sample depicted in FIG. 7C was prepared according to the “AG 8 Cu II” sample condition listed above in Table 1. Further, the sample depicted in FIG. 7D was prepared according to the “AG 8 Cu IV” sample condition listed above in Table 1. As FIGS. 7A, 7B, 7C and 7D demonstrate, the nano-sized protrusions can exhibit conical and pillar-like shapes, respectively, that are dependent on dry etching time and continuous film thickness parameters.

In Table 1 above, the transmittance and haze data was measured by a BYK-Gardner GmbH haze meter with 0°/diffuse geometry test conditions. The haze meter employed to generate the data in Table 1 is a single port system with an integrated sphere diameter, and no wavelength spectrometer capability. The port diameter size is about 1 inch and the sphere diameter is about 150 mm. It is evident from the data in Table 1 that the addition of the AR surfaces on top of the AG surfaces yields haze data that is comparable to those exhibited by substrates having only an AG surface while providing improved transmittance (i.e., reduced reflection).

In addition, the samples in Table 1 were optically characterized by measuring the total, axial (direct) and reflection using a PerkinElmer, Inc. Lambda 950 UV/Vis/NIR spectrophotometer system. The system was periodically calibrated according to ASTM recommended procedures using absolute physical standards, or standards traceable to the National Institute of Standards and Technology (NIST). As shown in FIG. 8A, plot that presents total, axial and diffuse optical transmission and reflection data for AG micro-textured and AR nano-textured surfaces designated by the following sample preparation conditions from Table 1: “AG 4 Cu I,” “AG4 Cu II,” “AG 8 Cu II,” and “AG 8 Cu IV.” It is evident from the data in FIG. 8A that all samples produce a flat AR effect with high optical transmission levels. Further, the haze levels exhibited by these samples are roughly the same as the haze level observed in the sample having only an AG, micro-textured surface (see Table 1).

FIGS. 8B and 8C are plots that present total and specular reflectivity data for AG micro-textured and AR nano-textured surfaces designated by the following sample preparation conditions from Table 1 above: “AG 4 Cu I,” “AG4 Cu II,” “AG 8 Cu II,” and “AG 8 Cu IV.” These figures also include total and specular reflectivity data for a non-textured, flat surface as a comparison to the tested samples with AG/AR surfaces. It is evident from the data in FIGS. 8B and 8C that all AG/AR samples produce a flat AR effect with low specular reflectivity levels. It is also important to note that all of the AG/AR samples have reflectivity levels significantly below the reflectivity levels observed for the flat, non-textured sample lacking AG/AR surfaces.

In Table 1 above, the samples listed with water contact angle and oil contact angle data (“Water CA” and “Oil CA,” respectively) were treated with a Dow Corning® 2634 fluorosilane coating (see foregoing description in connection with hydrophobic coating 80). Several test measurements were made on each sample to generate the data shown in Table 1. It is evident from the results that the contact angle for water can be higher than 165 degrees for the listed AR/AG samples (e.g., “AG 4 Cu II” and “AG 4 Cu I”), significantly higher than contact angles measured for samples containing only AR surfaces (e.g., in the range of 140 to 150 degrees).

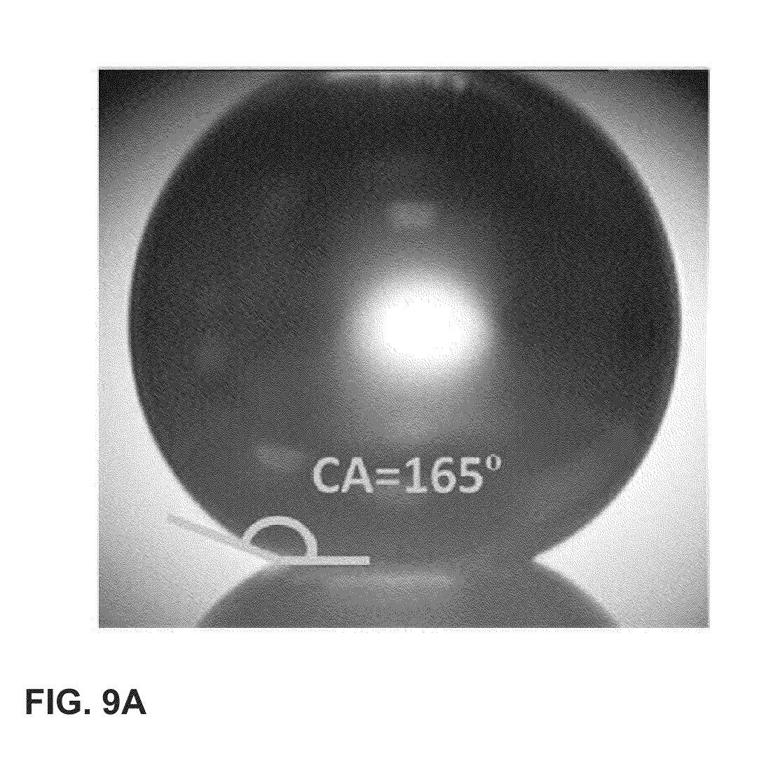

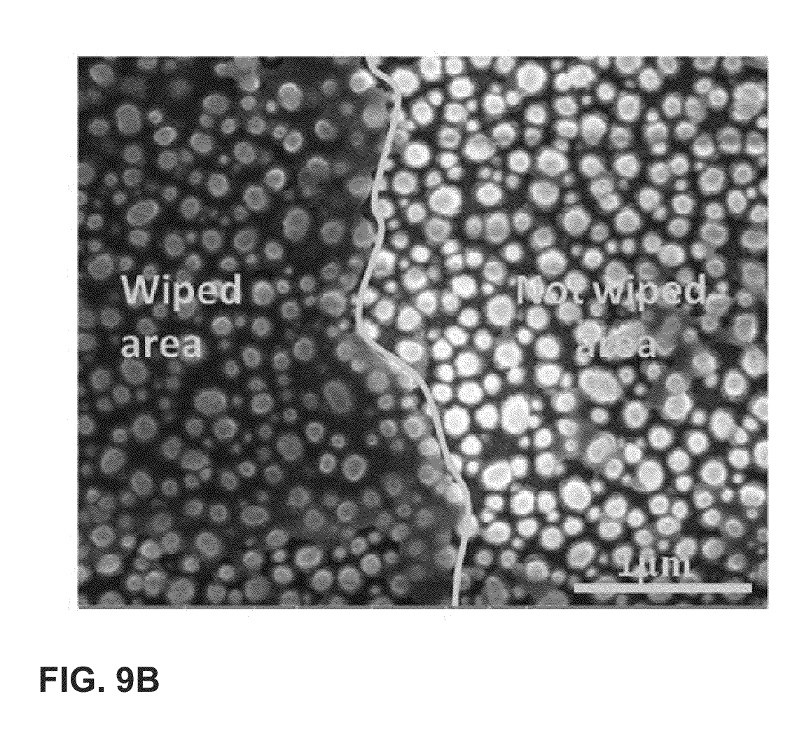

As shown in FIG. 9A, a photo of a 2 mL water droplet on an AG micro-textured and AR nano-textured surface having a fluorosilane coating is provided demonstrating a contact angle of approximately 165 degrees. The sample employed for this test is consistent with samples prepared according to the “AG 4 Cu I,” “AG 4 Cu II,” and “AG 8 Cu II” conditions in Table 1. Advantageously, the underlying roughness of the AG surfaces significantly contributes to the superhydrophobic behavior of the textured article depicted in FIG. 9A. This is likely the effect from the high roughness of the AG surface that leads to a larger freely suspended water meniscus in air than would have been achieved by the AR structure alone.

FIG. 9B is an SEM image of the AG micro-textured and AR nano-textured surface depicted in FIG. 9A after portions of it were subjected to 100 wipes with a fiber cloth at a force of 6 N over a surface area of 2 cm². The wipe test was conducted using a fiber cloth with an AATCC crockmeter (SDLAtlas CM-5). More specifically, the crockmeter test consisted of 10 and 100 wipes on a sample prepared according to the “AG 8 Cu II” condition (see Table 1 above), and the resultant optical transmission and water contact angles were measured. The optical transmission was initially reduced by about 0.5% after 10 wipes and then remained fairly constant after 100 wipes. The contact angle for water decreased only slightly, about 4% after 100 wipes (from 165 degrees to 158 degrees). The corresponding roll-off angle was below 10 degrees. These results demonstrate that a more pronounced AG micro-textured surface can aid in the protection of the AG nano-textured surface without the need for any additional treatments. Nevertheless, chemical strengthening according to the foregoing methods described in connection with textured article 100a can further increase the mechanical resistance of the nano-sized protrusions.

It will be apparent to those skilled in the art that various modifications and variations can be made to the textured articles 100, 100a and the methods of making them without departing from the spirit and scope of the claims.

We claim:

1. An article, comprising:
a transparent substrate having at least one primary surface;
a micro-textured surface on the primary surface of the substrate, the micro-textured surface comprising a plurality of hillocks; and
a nano-textured surface on the micro-textured surface, the nano-textured surface comprising a plurality of nano-sized protrusions,
wherein the hillocks have an average height of about 10 to about 1000 nm and an average longest lateral cross-sectional dimension of about 1 to about 100 μm, and the nano-sized protrusions have an average height of about 10 to about 500 nm and an average longest lateral cross-sectional dimension of about 10 to about 500 nm.

2. The article of claim 1, wherein the nano-sized protrusions have an average height of about 10 to about 300 nm and an average longest lateral cross-sectional dimension of about 10 to 300 nm.

3. The article of claim 1, wherein the hillocks have an average height of about 50 to about 500 nm and an average longest lateral cross-sectional dimension of about 1 to about 100 μm.

4. The article of claim 1, wherein the plurality of nano-sized protrusions cover about 30 to 70% of the micro-textured surface and the nano-sized protrusions are defined by a substantially conical geometry.

5. The article of claim 1, wherein an optical transmittance of the textured article is greater than or equal to about 92 percent over a visible spectrum of light.

6. The article of claim 1, wherein an optical transmittance of the textured article is greater than or equal to about 95 percent over a visible spectrum of light.

7. The article of claim 1, wherein a haze of the textured article is less than or equal to about 2 percent.

8. The article of claim 1, further comprising:
a fluorosilane coating on the nano- and micro-textured surfaces, wherein a contact angle between water and the coating is greater than or equal to 150 degrees.

9. The article of claim 8, wherein a reduction in the contact angle is 10% or less after 100 wipes with a fiber cloth, each wipe applying a force of about 6 N over a 2 cm² portion of the primary surface.

10. An article, comprising:
a transparent substrate having at least one primary surface;
a micro-textured surface on the primary surface of the substrate, the micro-textured surface comprising a plurality of hillocks; and
a nano-structured surface on the micro-textured surface,
wherein the hillocks have an average height of about 10 to about 1000 nm and an average longest lateral cross-sectional dimension of about 1 to about 100 μm.

11. The article of claim 10, wherein the nano-structured surface comprises either one or both of: a nano-textured surface, and a compositionally nano-structured surface.

12. The article of claim 11, wherein the nano-structured surface comprises a plurality of nano-sized protrusions having an average height of about 10 to about 500 nm, and an average longest lateral cross-sectional dimension of about 10 to about 500 nm.

13. The article of claim 11, wherein the compositionally nano-structured surface comprises a multi-layer coating disposed on the micro-textured surface.

14. The article of claim 11, wherein the substrate is chemically strengthened and has a compressive stress greater than about 500 MPa and a compressive depth-of-layer greater than about 15 μm.

15. The article of claim 11, wherein either one or both of the micro-textured and nano-structured surfaces are chemically strengthened and have a compressive stress greater than about 500 MPa.

16. The article of claim 10, wherein the hillocks have an average height of about 50 to about 500 nm and an average longest lateral cross-sectional dimension of about 1 to about 100 μm.

17. The article of claim 12, wherein the plurality of nano-sized protrusions cover about 30 to 70% of the micro-textured surface and the nano-sized protrusions are defined by a substantially conical geometry.

18. The article of claim 10, wherein an optical transmittance of the article is greater than or equal to about 92 percent over a visible spectrum of light.

19. The article of claim 10, wherein an optical transmittance of the article is greater than or equal to about 95 percent over a visible spectrum of light.

20. The article of claim 10, wherein a haze of the article is less than or equal to about 2 percent.

21. The article of claim 10, further comprising:
a fluorosilane coating on the nano-structured and micro-textured surfaces, wherein a contact angle between water and the coating is greater than or equal to 150 degrees.

22. The article of claim 21, wherein a reduction in the contact angle is 10% or less after 100 wipes with a fiber cloth, each wipe applying a force of about 6 N over a 2 cm² portion of the primary surface.

23. A method of forming an article, the method comprising the steps:
providing a transparent substrate having at least one primary surface and a glass, glass-ceramic or ceramic composition;
forming a micro-textured surface on the primary surface of the substrate, the micro-textured surface comprising a plurality of hillocks; and
forming a nano-structured surface on the micro-textured surface, the nano-structured surface comprising a nano-textured surface or a compositionally nano-structured surface.

24. The method of claim 23, wherein forming a nano-structured surface comprises:
forming a continuous ultra-thin metal-containing film or film stack on the micro-textured surface;
dewetting at least a portion of the continuous ultra-thin metal-containing film or film stack to produce a plurality of discrete metal-containing dewetted islands on the micro-textured surface; and
dry etching at least portions of the micro-textured surface on which the islands are not disposed to define a nano-textured surface on the micro-textured surface, the nano-textured surface comprising a plurality of nano-sized protrusions.

25. The method of claim 24, wherein the dewetting is conducted at 300° C. or higher.

26. The method of claim 24, wherein the dewetting is conducted at 500° C. or higher.

27. The method of claim 23, wherein forming a nano-structured surface comprises:
forming a multi-layer coating on the micro-textured surface, wherein the multi-layer coating comprises a plurality of layers having a nano-scale thickness.

28. The article of claim 1, further comprising:
a first interface between the transparent substrate and the micro-textured surface; and
a second interface between the micro-textured surface and the nano-textured surface,
wherein the interfaces have a thickness that is substantially shorter than the thicknesses of the surfaces, and
further wherein the substrate, the micro-textured surface, and the nano-textured surface have substantially the same composition comprising a glass, glass-ceramic or a ceramic material.

29. The article of claim 28, wherein each of the surfaces has a total optical reflectance and/or specular reflectance of less than 2% across a substantial portion of the visible light spectrum.

30. The article of claim 1, wherein each of the surfaces and the substrate are monolithic such that no interface is discernible between the substrate and the micro-textured surface or the micro-textured surface and the nano-textured surface.
